(19) United States
(12) Patent Application Publication
(10) Pub. No.: US 2022/0366107 A1
(43) Pub. Date: Nov. 17, 2022

(54) COMPUTER IMPLEMENTED METHOD FOR SIMULATION OF TIRE PERFORMANCE

(71) Applicant: Siemens Industry Software Netherlands B.V., Eindhoven (NL)

(72) Inventor: Ioannis Konstantinou, Eindhoven (NL)

(21) Appl. No.: 17/771,098

(22) PCT Filed: Jun. 15, 2020
(86) PCT No.: PCT/EP2020/066497

§ 371 Date: Apr. 22, 2022

(30) Foreign Application Priority Data
Oct. 31, 2019 (EP) 19206438.4
Mar. 12, 2020 (EP) 20162749.4

(51) Int. Cl. G06F 30/23

(52) U.S. Cl. CPC G06F 30/23; G06F 2111/10

(57) ABSTRACT

A computer implemented method for simulation of tire performance of a vehicle is provided. The method includes providing a computer implemented tire model that receives as an input a vehicle velocity related parameter and generates as an output a tire driving force related parameter. To improve accuracy and performance of simulation of tire performance, a computer implemented tire property model is provided. The tire property model includes a tire temperature model that receives as an input the vehicle velocity related parameter. The tire temperature model also receives as an input from the tire model the tire driving force related parameter. The tire temperature model generates as an output a temperature parameter characteristic for the tire temperature, and transmits the tire temperature parameter to the tire model as an additional input. Systems for such simulations and tire modeling devices including computers with simulation software are also disclosed.

The present patent document is a § 371 nationalization of PCT Application Serial No. PCT/EP2020/066497, filed Jun. 15, 2020, designating the United States, which is hereby incorporated by reference, and this patent document also claims the benefit of European Patent Application No. 19206438.4, filed Oct. 31, 2019, and European Patent Application No. 20162749.4, filed Mar. 12, 2020, which are also hereby incorporated by reference.

### FIELD

The disclosure relates to a computer implemented method for simulation of tire performance, a system for such a simulation, and a tire modeling device including a computer with an according simulation software.

### BACKGROUND

From U.S. Pat. No. 9,636,955 B2, a tire-based system for real-time estimation of a temperature of a radially outward tire surface is known including: at least one tire inner liner temperature sensor mounted to the tire operative to measure a tire inner liner temperature and an algorithmic prediction model correlating inner liner tire temperature to the temperature of the tire radially outward surface for the combination represented by the identified tire and the identified vehicle, the algorithmic prediction model operatively receiving the steady-state inputs and the transient behavior vehicle-based inputs and generating based upon the steady-state inputs and the transient behavior inputs a real-time estimation of the temperature of the radially outward surface of the vehicle tire during vehicle operation.

From US 2010/0010795 A1, a process for simulating the physical behavior of a vehicle tire rolling on the ground including temperature modelling.

### SUMMARY

The scope of the present disclosure is defined solely by the appended claims and is not affected to any degree by the statements within this summary. The present embodiments may obviate one or more of the drawbacks or limitations in the related art.

Material mechanical properties depend upon several factors. Stress, as a reaction to applied strain, depends for example on the strain amplitude and frequency (non-linearity), strain orientation (anisotropicity), and temperature. Rubber compounds used in tire construction have a strong dependency on strain amplitude and frequency as well as temperature. It was observed that that the cornering stiffness at 4000 N load may decrease by almost 50% at a temperature increase of 70° C.

In motorsport, where the tire force and rolling speed reaches higher levels with respect to the typical operating conditions of passenger cars, the prediction and control of the tire temperature and its effects on the response are of crucial importance to set up a performant vehicle.

Applied research has also been conducted in the domain of passenger cars, studying the mutual interactions between tire response and temperature. Based on experimental evidence and the relevant theory, some trends of the most important tire parameters as a function of temperature are studied in C. Angrick, et al., “Influence of Tire Core and Surface Temperature on Lateral Tire Characteristics,” SAE Int. J. Passeng. Cars—Mech. Syst. 7(2), doi: 10.4271/2014-01-0074 (2014). This study concludes that:

(a) the cornering stiffness and lateral stiffness of the tire monotonically decrease with the temperature; (b) no significative trend may be observed in the relaxation length; and (c) the peak friction largely depends on temperature and a maximum value may be observed at a given level.

In A. Corollaro, “Essentiality of Temperature Management while Modeling and Analyzing Tires Contact Forces,” (2014), the tire volume is split in the radial direction by two elements: the surface layer and the bulk layer. The temperature of these elements is averaged along the circumferential and lateral directions. They exchange heat along their contact interface as well as surrounding elements, for example the ambient air and the road. Heat is produced by frictional forces in the contact patch and rolling resistance. Finally, a scaling factor for the cornering stiffness is calculated based on physical considerations that take into account the dependency of the tire constructive elements on temperature.

In P. Fèvrier, et al. “Thermal and Mechanical Tyre Modelling for Handling Simulation,” ATZ 0512008 Volume 110 (2008), the Fourier diffusion equation is integrated to determine the temperature distribution along the radial direction. Also in this model, the temperature is averaged along the circumferential and lateral directions. Heat is exchanged at the interface with the surrounding elements; rolling resistance and frictional forces are considered as heat sources.

The force produced by the tire in conditions of slip are predicted by a physical model, based on an improved version of the brush model that is described in H. B. Pacjeka, “Tire and Vehicle Dynamics,” Third Edition (2012). The effect of temperature on the tire characteristics is in this case considered by introducing the dependency of the material characteristics (e.g., tread shear stiffness, frictional properties) of the brush model elements.

In F. Farroni, et al., “TRT: thermo racing tyre a physical model to predict the tyre temperature distribution,” Meccanica, DOI 10.1007/s11012-013-9821-9 (2013), the Fourier diffusion equation is integrated in the three-dimensional tire volume permitting thus to fully capture effects that arise from (a) the asymmetrical contact pressure and sliding velocity distribution that may be observed for example during lateral slip excitations and (b) the temperature gradient along the circumferential direction that is produced for example when large frictional forces are produced by a tire that rolls at a low speed. The tire volume is approximated by a parallelepiped that represents the package belt/treads unwound along the longitudinal direction.

The effect of temperature on the tire performance is modeled by appropriate scaling of a so-called Magic Formula slip model (see US 2011/0209521 A1). The model parameters are identified by vehicle outdoor testing as well as laboratory material experiments.

In F. Calabrese, et al., “A Detailed Thermo-Mechanical Tire Model for Advanced Handling Applications,” SAE Int. J. Passeng. Cars- Mech. Syst. 8(2), doi:10.4271/2015-01-0655 (2015), the full three-dimensional tire volume is described by interconnected layers that represent the different structural elements of the package belt/treads as well as the sidewalls. This approach, interconnected with a full three-dimensional structural model of the tire, permits detailed evaluation of the effect of the temperature on the local interactions between tire and road. It is also possible to couple the model with a Magic Formula slip model for a more efficient numerical calculation.

A disadvantage of such known approaches may be that these are not suitable to be integrated with a practical technical implementation of the so-called Magic Formula

The general form of the Magic Formula, given by Pacejka, is:

y=D*sin(C*a tan(B*x−E*(B*x−a tan(B*x))))

where B, C, D, and E represent fitting constants, and y is a force or moment resulting from a slip parameter x (see Pacejka, H. B. (2012), “Tire and vehicle dynamics,” Besselink, Igo (3rd ed.), Oxford: Butterworth-Heinemann. p. 165). The Magic Formula is used in many variants for accurate vehicle dynamics simulations like described in: MF-Tyre/MF-Swift: https://tass.plm.automation.siemens.com/delft-tyre-mf-tyremf-swift (2020) or Hans-Peter Willumeit, Modelle and Modellierungsverfahren in der Fahrzeugdynamik, Springer-Verlag, 13.08.2013-404 Seiten.

It is therefore a goal of the present disclosure to provide a thermodynamic model, based on at least one of the following design requirements: (1) Possibility of full integration into existing models—like Magic Formula, (2) Parameter identification based on measurements of tire forces and moments, only extended with a set of temperature sensors, (3) Possibility to plug the model on the top of a previously identified parameter set of another model, or (4) Low computational effort during a numerical simulation such as to permit real time model calculation on commercially available hardware.

According to a first aspect, a computer implemented method is provided.

Terms like axial, radial, tangential, or circumferential, and related terms respectively relate to a rotation axis of a tire or a wheel, if not indicated differently.

According to another aspect, the tire temperature model employing the Fourier law of diffusion for modeling of a temperature distribution within the tire, the temperature distribution being modeled with heat sinks, heat sources, and the thermal properties of the material. The tire temperature model may generate the temperature distribution as a three-dimensional field.

According to another aspect, the tire temperature model generates an output of a temperature distribution, e.g., as a one-dimensional temperature distribution, such as indicating the temperature distribution in the radial direction of the tire rubber and may be additionally the tire carcass and/or the gas in the tire gas cavity.

According to another aspect, the tire temperature model generates an output of a three-dimensional temperature distribution of the tire—mutatis mutandis.

According to another aspect, the tire temperature model may determine the temperature distribution of the solid parts of the tire only or may consider the gaseous portion in the tire gas cavity in case of an inflated tire as well. The tire may be modeled as a simplified single component part or as including a composite structure which may be composed at least in part layer-wise.

The tire carcass may be the component that provides the structural stiffness of the tire and may be composed by radial cords and belt plies of different kind of materials such as polyester, steel, and textiles. According to another aspect, the tire temperature model may set an elasticity modulus of steel components of the tire in the operating range of a tire to be independent of temperature.

According to another aspect, regarding at least some components of the tire, the tire temperature model may set an elasticity modulus of steel to be independent of temperature.

According to another aspect, regarding at least some components of the tire, the tire temperature model may set an elasticity modulus of polyester and/or of textile materials of the tire (e.g., Kevlar) to be independent of temperature, if it operates below the glass transition temperature.

According to another aspect, it may be assumed that the only element in the tire having properties sensitive to temperature are made of rubber, respectively, the only component is the tire rubber.

According to another aspect, the tire temperature model may set that the only element in the tire having properties sensitive to temperature are the tire treads made of rubber.

According to another aspect, the tire temperature model may consider the tread height profile and the void ratio (ratio of the volume of space between the tread blocks to the volume of the tread blocks) with an adjustment of the density of the rubber compound and the specific heat. In other words, the tread pattern may therefore be modelled as an ideal slick tire. The tread height profile and the void ratio are some of the most important parameters related to tire design.

According to another aspect, the tire temperature model may calculate the tread temperature by setting that the tread is subjected to the heat power sources and sinks continuously in time. This feature optimizes the CPU effort by neglecting a high frequency component physically generated because during a full revolution of a tire subjected to slip, the surface temperature of one tread increases when travelling through the contact patch and decreases on its way back along the tire circumference. The travelling time of a tread along the contact patch is in the order of the milliseconds. To capture this high frequency dynamics in a numerical simulation, a sample rate in the order of the kHz is required.

According to another aspect, the tire temperature model may average tread surface temperature along the axial—respectively lateral—direction of the tire by a weighting function that designates the average temperature along the contact patch portion that most concur to the generation of frictional forces. According to the findings, a contact pressure profile and the contact patch shape determine to a large extent the distribution of the local frictional forces. The contact pressure profile is relatively constant along the lateral direction of a tire but, when a camber or side slip angle is applied, this profile becomes asymmetric. FIG. 7 depicts the measured contact pressure of a tire in both conditions without (a) and with (b) a camber angle. This effect results in a smaller contact area responsible for the production of the frictional force and becomes more sensitive to thermodynamic excitations.

According to another aspect, specific mass, specific heat capacity, and conduction of tread rubber compounds are assumed to be constant. The advantage of establishing a temperature independence of these parameters is a more linear model such that its numerical integration does not involve the inversion of matrices which would consume more computational resources.

According to another aspect, the tire temperature model determines the temperature parameter based on a volume of cylindrical shape uniformly excited.

According to another aspect, the tire temperature model may determine the temperature parameter based on: (a) rolling resistance heat power (QRR), (b) forces build-up heat power (QFR), (c) heat exchange with the road (Qr), (d) heat exchange with the ambient air (Qa), and (e) heat exchange with the core air (Qi).

The tire temperature model may average these excitations over one full tire revolution, (a) is applied to the cylinder volume, (b), (c), (d) are applied to the outer surface, and (e) is applied to the inner surface.

FIG. 2 depicts the cylindrical volume used to model the tire. Because the thermal excitations are uniformly applied along the circumferential and lateral directions, the thermodynamic problem simplifies in the temperature prediction of a one-dimensional element excited in the volume and its two extremities by the abovementioned inputs.

According to another aspect, the tire model may be in the general form (Magic Formula):

y=D*sin(C*a tan(B*x−E*(B*x−a tan(B*x)))).

According to another aspect, the tire temperature model may generate scaling factors and/or offsets to be applied to of the tire model, in particular to these above high-level parameters B, C, D, and E. As an advantage of this concept any process to determine B, C, D, and E doesn't need be modified when applying the tire temperature model to the tire model by the way of scaling factors. In this way, parts of the tire model related to different effects (e.g., vertical load, camber, inflation pressure, temperature, forward speed, etc.) are kept separated.

According to another aspect, the tire temperature model may calculate these scaling factors and offsets without dependency on of the slip quantities (longitudinal slip and/or side slip angle). This may be consistent with the tire model being able to capture the slip dependency for a given operating condition while the parameters B, C, D, and E model this dependency for different operating conditions. As an exception to this rule, the parameter E may be dependent on the sign of the slip quantity.

According to another aspect, the tire temperature model generated scaling factors may be equal to unity and the offsets may be equal to zero when the temperature is equal to a given nominal value resp. a reference value. The nominal value corresponds to a reference temperature at which a respective parameter to be scaled was determined for example by experimental verification respectively measurement.

According to another aspect, the parameters of the tire model may be identified with a measurement protocol that may include steady state slip sweeps for different operating conditions (e.g., vertical load, camber angle, etc.). This may be called the reference or default measurement protocol. The parameters of the tire temperature model may be identified with a measurement protocol that includes steady state sweeps for different operating conditions at different temperatures and forward speeds. This may be referred to as the extended measurement protocol.

According to another aspect, the tire driving force related parameter includes at least one of: vehicle velocity, tire angular velocity.

According to another aspect, the vehicle velocity related parameter includes at least one of: tire driving force and/or tire driving momentum.

According to another aspect, the tire model includes at least one of the following tire model parameters: total vehicle mass, inertia moment around center of mass, wheel base, distance from center of mass to front axle, distance from center of mass to rear axle, height of the center of mass, cornering stiffness at front axle in nominal conditions, cornering stiffness at rear axle in nominal conditions and further roll inertia moment, pitch inertia moment, frontal area, aerodynamic drag, wheel track at front axle, unsprung mass, static toe angle, static camber angle, steering compliance lateral, steering compliance yaw, suspension spring, roll bar.

The disclosure also relates to a system for simulation of tire performance of a vehicle or to a vehicle including such a system. This system employing a method according to at least one of the preceding described embodiments referring to a computer implemented method for simulation of tire performance of a vehicle.

The disclosure also relates to a tire modeling device including a computer with a simulation software, the simulation software applying a method according to at least one of the preceding described embodiments referring to a computer implemented method for simulation of tire performance of a vehicle.

### BRIEF DESCRIPTION OF THE DRAWINGS

Embodiments of the disclosure are now described, by way of example only, with reference to the accompanying drawings, of which:

FIG. 1 depicts an example of a tire to be simulated by a method according to the disclosure.

FIG. 2 depicts an example of a tire geometry illustrating some settings of the method.

FIG. 3 depicts a diagram illustrating an example of the method.

FIGS. 4 to 6 respectively depict a chart showing the transformation of a simulated temperature parameter into a scaling factor.

FIG. 7 depicts the measured contact patch pressure of a tire in both conditions without (a) and with (b) a camber angle.

The illustration in the drawings is in schematic form. It is noted that in different figures, similar or identical elements may be provided with the same reference signs.

### DETAILED DESCRIPTION

Although the present disclosure has been described in detail with reference to certain embodiments, the present disclosure is not limited by these examples, and that numerous additional modifications and variations may be made thereto by a person skilled in the art without departing from the scope of the disclosure.

The use of “a” or “an” throughout this application does not exclude a plurality, and “comprising” does not exclude other steps or elements. Also, elements described in association with different embodiments may be combined.

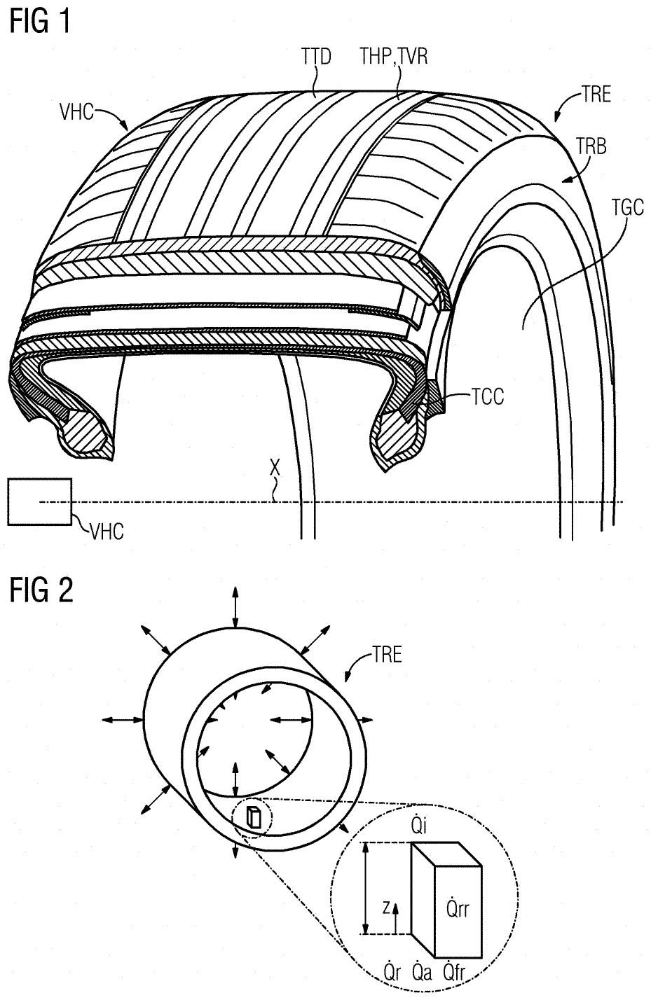

FIG. 1 shows a tire TRE which may be the object for simulation of tire performance of a vehicle VHC (rest of vehicle VHC schematically illustrated by a box) by a computer implemented method CIM. The tire TRE may be rotatable to an axis X and includes a tire carcass TCC, tire rubber TRB, tire treads TTD, tire carcass TCC, tire gas cavity TGC, tread height profile THP, void ratio TVR.

FIG. 2 shows a tire TRE as it may be modeled for temperature prediction based on a volume of cylindrical shape uniformly excited by: rolling resistance heat power Qrr, forces build-up heat power Qfr, heat exchange with the road Qr, heat exchange with the ambient air Qa, heat exchange with the core air Qi.

All the excitations are averaged over one full tire revolution, a is applied to the cylinder volume; b, c, and d are applied to the outer surface; and e is applied to the inner surface. FIG. 2 depicts the cylindrical volume of height h as it may be used to model the tire TRE. Because the thermal excitations may be uniformly applied along the circumferential and lateral directions, the thermodynamic problem may be simplified to a temperature prediction of a one-dimensional element excited in the volume and its two extremities.

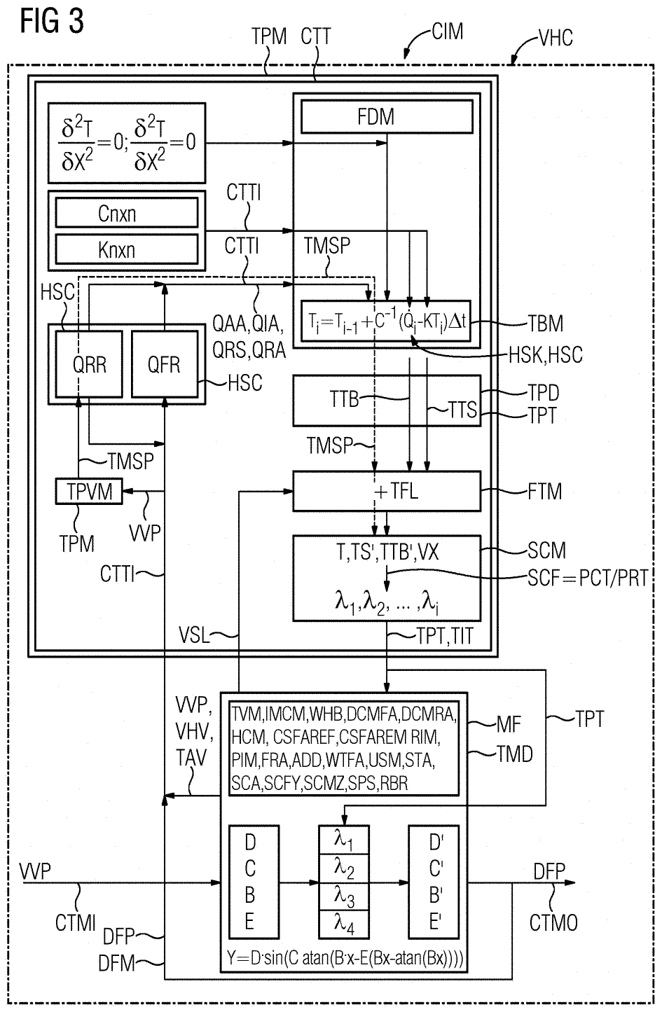

FIG. 3 shows a diagram illustrating an example of a computer implemented method CIM for simulation of tire TRE performance of a vehicle VHC.

The method includes providing a computer implemented tire model TMD, wherein the tire model TMD receives as an input CTMI at least a vehicle velocity related parameter VVP.

As indicated by the dotted line box, the method may relate to a vehicle VHC including the tire modeling device including a computer with a simulation software, the simulation software applying a method according to at least one of the described embodiments referring to a computer implemented method for simulation of tire performance of the vehicle VHC.

The tire model TMD generating as an output CTMO at least a tire driving force related parameter DFP. A tire property model TPM including a tire temperature model CTT. In this example no additional components of the tire property model TPM are illustrated.

The tire temperature model CTT receiving as an input CTTI the vehicle velocity related parameter(s) VVP. This input CTTI may be a vehicle velocity VHV and/or a tire angular velocity TAV. The tire temperature model CTT receiving as an input CTTI from the tire model TMD a tire driving force related parameter DFP. The tire temperature model CTT generating as an output CTTO a temperature parameter TPT characteristic for the tire temperature TIT and transmitting the tire temperature parameter TPT to the tire model TMD as an additional input CTMI.

Rolling resistance is generated by the cyclical deformations of the tire TRE materials when rolling under vertical load. Such deformations may occur in different parts of the tire TRE volume and may be related by different physical phenomena: (a) compression of the sidewalls along the contact patch, (b) bending of the belt when entering and exiting the contact patch, (c) tire treads TTD vertical deformation, and (d) tread shear during their travel in the contact patch.

The sidewalls may be not in the scope of the tire temperature model CTT. The rolling resistance components related to the tire treads TTD and belt may be considered. The tire treads TTD may be thicker and entirely made by tire rubber TRB and may constitute the dominant element that may be introduced in the tire temperature model CTT. The rolling resistance heat source QRR may be determined by the equation:

$${\dot{Q}}_{rr} = π ( \frac{b {P}_{i}^{2}}{2 {E}^{′}} + \frac{{E}^{′} {F}_{Z}^{2}}{24 b {{P}_{i}^{2} ( {R}_{0} - {h}_{t} )}^{2}} ) {c}_{s r} {h}_{t} sin δ {V}_{x} \qquad ( 1 )$$

wherein: b is the half contact patch width, ht the tread profile height, R0 the unloaded radius, Pi the inflation pressure, Fz the vertical load, csr the contact surface ratio, and Vx the forward speed. The storage modulus E′ and the phase delay d are defined in equations (11) and (12). Some of these parameters respectively thermal properties TPM like tire material stiffness parameters TMSP may be supplied by a tire property velocity model TPVM, e.g., partly based on vehicle velocity related parameter VVP and/or driving force related parameter DFP (or driving momentum DFM).

To produce forces, the tire TRE undergoes deformations (e.g., tread shearing in the contact patch) and some elements slide over the contact surface (e.g., treads sliding on the road).

The power dissipated by these effects may be determined by calculation of the power balance of a tire TRE that rolls at speed Vx, a driving moment Mwd applied at the center of wheel and a side slip angle a. From the definition of longitudinal slip, a relation between the wheel angular speed W and Vx may be established:

$$Ω = \frac{{V}_{x} ( 1 + κ )}{{R}_{e}} \qquad ( 2 )$$

wherein k is the longitudinal slip and Re the effective rolling radius.

The generated heat power may be the difference of all the power entering and exiting from the tire:

\dot{Q}_{fr}=M_{wd}Ω+F_{y}V_{sy}−FₓVₓ (3)

From equation (2) and (3) and applying the approximation Rₗ≈Rₑ with Rₗ the loaded radius, it results:

\dot{Q}_{fr}≈FₓVₓ(1+K)+F_{y}V_{sy}−FₓVₓ=FₓVₛₓ+F_{y}V_{sy} (4)

Equation (4) states that the heat source HSC, respectively the heat source HSC from generating forces QFR may be equal to the scalar product between the force and the contact patch sliding velocity vectors.

The heat exchange between the tire and external ambient air (heat flux QAA) and with the internal core air (heat flux QIA) may be modeled with the convection coefficients hₐ and hᵢ respectively.

\dot{Q}a=hₐ(Tₐ−Tₜ)Aₐ

\dot{Q}ᵢ=hᵢ(Tᵢ−Tₜ)Aᵢ (5)

where Tₜ is the tread surface temperature TST, Tₗ the tire liner temperature, Tₐ the ambient air temperature, Tᵢ the core air temperature, Aₐ and Aᵢ the outer and inner exchange surfaces, respectively.

These coefficients may depend on the tire rolling speed and tire construction, hₐ may also depend on the tread design and the airflow that surrounds the tire TRE during operation. This coefficient relies therefore also on vehicle constructive and aerodynamics parameters.

On similar grounds the heat exchange with the road surface QRS may read:

\dot{Q}ᵣ=hₜ(Tᵣ−Tₜ)A_{c} (6)

wherein hₜ is the conduction coefficient, Tᵣ the road temperature, and A_{c} the contact patch area.

The core air in turn may exchange heat with the rim whose temperature may depend on the ambient air and other thermodynamic inputs (e.g., braking system) and may strongly depend therefore on vehicle constructive parameters. When missing these design parameters, this heat exchange may be modeled on the assumption that the rim temperature is equal to the ambient air temperature. This assumption may be valid as long as there are no external heat sources, the rim thermal mass may be low, and its heat conductivity may be high. This results in the following equation for heat flux to/from rim QRA:

\dot{Q}_{c}=hᵣ(Tᵢ−Tₐ)Aᵣ (7)

wherein hᵣ is the rim/air convection coefficient and Aᵣ the exchange area.

The temperature state in the tire volume respectively the tire temperature model CTT may be governed by the Fourier diffusion model FDM:

$$\frac{\partial T}{\partial t} = \frac{k}{{c}_{p} ρ} {∇}^{2} T + \frac{\dot{Q}}{{c}_{p} ρ} \qquad ( 8 )$$

wherein k is the material thermal conductivity, cₚ the specific heat capacity, ρ the specific mass, and \dot{Q} the total of all the heat sources HSC and heat sinks HSK. Equation (8) states that, for a given point in the volume, the change of its temperature over time is proportional to the sum of the heat Qi directly introduced (\dot{Q}) and the difference of the heat flowing in and out from all the adjacent points.

In general, T and \dot{Q} are functions of the three space coordinates and time. Under the assumptions described above (see FIG. 2), they become a function of the space coordinate z and time only.

$$\frac{\partial T}{\partial t} = \frac{k}{{c}_{p} ρ} \frac{{\partial }^{2} T}{\partial {z}^{2}} + \frac{\dot{Q}}{{c}_{p} ρ} \qquad ( 9 )$$

Equation (9)— the Fourier diffusion model (FDM)—may be numerically integrated with a FEM method, leading to the bulk temperature model TBM. At the time step: i

Tᵢ=Tᵢ₋₁+C⁻¹(\dot{Q}ᵢ−K Tᵢ)Δt (10)

wherein C ∈ [symbol] ^{nxn}(Cnxn in FIG. 3) and K ∈ [symbol] (Knxn in FIG. 3) are respectively the thermal mass and thermal conductivity matrices and n the number of discretization elements along the coordinate z.

Based on the assumption of material properties independent of temperature and a fixed simulation time step Δt, integration of equation (10) may require one matrix inversion for initialization and only matrices additions and multiplications during the simulation, making the method very efficient from the perspective of CPU effort.

The matrices C and K of the tire temperature model CTT may be tridiagonal and contain the material properties of every discretization element. A total of 7-14 elements, (e.g., 10 elements), may be applied in the tire temperature model CTT, e.g., with two types of material characteristics for the elements corresponding to the belt and the elements corresponding to the tire rubber TRB. According to the findings of the disclosure, an increase of the number or type of elements may not sensibly increase the model accuracy.

During sliding on a rough surface, a rubber tread may be excited and may dissipate different levels of heat power at different length scales. That temperature increases at length scales in the order of the 10⁻⁶ m, at the contact interface between the surface and rubber tread may significantly affect the produced frictional forces. Because of the small amount of thermal mass involved, this temperature may react with low delay to thermodynamic excitations (e.g., heat produced by frictional forces).

Modeling of this kind of a flash temperature TFL applying the Fourier diffusion model may require the adoption of many small discretization elements in the volume close to the contact surface. This will make a numerical solution computationally expensive. The flash temperature TFL may be modeled as an instantaneous increase of temperature that depends on the sliding velocity VSL and may be added on the top of the background temperature (flash temperature module FTM, as shown in FIG. 3) respectively tire surface temperature TTS calculated with equation (10), which accounts for the diffusion of temperature at the larger length scales only.

The performance of a tire TRE is significantly influenced by the material properties of the tread rubber compound (tire rubber TRB, tire treads TTD). The stress that a rubber tread at a given temperature produces when submitted to strain of a given amplitude and frequency is of importance for the determination of the most important tire TRE characteristics.

Mechanical material properties may be tested in a laboratory by conducting dynamic mechanical analysis, which includes cyclically exciting a material sample with strain at different frequencies. On rubber, the response may be modelled by the following equation:

σ=E*ε=(E′+i E″)ε (11)

wherein σ indicates the measured stress, E the applied strain, i the imaginary unit, and E* the complex modulus.

E* is a complex number of components E′ (storage modulus) and E″ (loss modulus). Purely elastic materials may be characterized by E″=0 (stress and strain are in phase) and purely viscous materials by E′=0 (strain presents π/2 rad phase delay with respect to stress). Rubber is a viscoelastic material (E′ ≠0, E″≠0) with the strain presenting a phase delay (δ) in the range [0, π/2] rad depending on the ratio between E″ and E′ (dissipation factor):

$$tan δ = \frac{{E}^{″}}{{E}^{′}} tan δ = \frac{{E}^{″}}{{E}^{′}} \qquad ( 12 )$$

E′, E″, and tan S depend on the excitation frequency and on the temperature for rubber compounds. The storage and loss moduli monotonically decrease with the temperature and increase with the excitation frequency: the material responds stiffer when excited at a lower temperature and/or higher frequency. The dissipation factor presents a peak at a given temperature and this peak moves to higher temperatures when the excitation frequency increases. The peak represents the transition between the rubbery state (high temperature, low frequency) and the glassy state (low temperature, high frequency) and it is the state where the rubber dissipates the most energy when excited.

The tread shear stiffness influences the tire TRE characteristics at low level of slip: the longitudinal slip stiffness C_{FK} and cornering stiffness C_{Fa}. The so-called brush model provides a simple analytical formulation between these quantities and the tread shear stiffness per unit of length in respectively the longitudinal (cₚₓ) and the lateral (c_{py}) directions:

$$\{ \begin{matrix}{C}_{F κ} = 2 {c}_{px} {a}^{2} \\ {C}_{F α} = 2 {c}_{py} {a}^{2}\end{matrix} \qquad ( 13 )$$

Considering pure shearing (and neglecting the flexion) of the tread elements in the contact patch, the tread shear stiffness may be worked out:

$${c}_{px} = \frac{{E}^{*}}{2 ( 1 + v )} \frac{2 b}{{h}_{t}} \qquad ( 14 )$$

wherein v is the Poisson ratio, b is the contact patch width, and hₜ the tread profile height.

It is observed that the tread shear stiffness is proportional to the complex modulus E*. Because the complex modulus monotonically decreases with temperature and increases with the excitation frequency, the slip stiffness of a tire rolling on a given road decreases with the temperature and increases with the rolling speed.

The tread shear stiffness influences also other quantities, for example the contact patch shear stiffness, which in turn affects other tire structural properties as the tire overall stiffness and the relaxation length.

Generating friction of a rubber tread sliding on a hard surface at a given roughness wavelength λ₀ it may be assumed that:

$$μ ∝ \frac{Im {E}^{*} ( {q}_{0} {V}_{s} , T )}{\vert {E}^{*} ( {q}_{0} {V}_{s} , T ) \vert} \qquad ( 15 )$$

where q₀=2π/λ₀ is the wave vector at the wavelength λ₀.

With the dissipation factor (equation (12)), it results that:

$$\frac{Im {E}^{*} ( {q}_{0} {V}_{s} , T )}{\vert {E}^{*} ( {q}_{0} {V}_{s} , T ) \vert} = sin δ ≅ tan δ \qquad ( 16 )$$

At the wavelength λ₀ and sliding speed Vₛ, the friction is the highest at the temperature where the dissipation factor is the largest. An asphalt road presents a wide spectrum of roughness wave lengths, but the friction may present a peak at a given temperature that depends on the sliding speed and the power spectrum density of the road roughness.

The tire model TMD may be based on the so-called Magic Formula which is an industrial standard in the automotive for accurately describing the forces and moments (here:driving force related parameter DFP) generated by a rolling tire TRE under constant slip inputs (longitudinal slip K and lateral slip α) and operating conditions (vertical load F_{z}, camber angle γ). The tire model TMD may also include the effect of the wheel trajectory curvature (turn slip) and inflation pressure. The general formulation of the tire model TMD may read:

y=D sin(C a tan(Bx−E(Bx−a tan(Bx)))) (13)

wherein y is a force and x is a slip quantity. The coefficients B, C, D and E becoming B′, C′, D′, E′, are quantities that depend on the operating conditions. They represent—to some extend—relationships with physical quantities and hence are subjected to related physical constraints. As an example, D may be related to a peak friction, BCD to a slip stiffness and C to a friction level at infinite slip.

The tire model TMD may include at least one of the following tire model parameters TMP: total vehicle mass TVM, inertia moment around center of mass IMCM, wheel base WHB, distance from center of mass to front axle DCMFA, distance from center of mass to rear axle DCMRA, height of the center of mass HCM, cornering stiffness at front axle in nominal conditions CSFAREF, cornering stiffness at rear axle in nominal conditions CSRAREF, roll inertia moment RIM, pitch inertia moment PIM, frontal area FRA, aerodynamic drag ADD, wheel track at front axle WTFA, unsprung mass USM, static toe angle STA, static camber angle SCA, steering compliance lateral SCFY, steering compliance yaw SCMZ, suspension spring SPS, roll bar RBR.

A scaling factor module SCM may generate a set of scaling factors λ1, λ2, λ3, λ4 and/or offsets that accordingly modify B, C, D, and E, becoming B′, C′, D′, E′, making them dependent on temperature (tire surface temperature TTS, tire bulk temperature TTB) and velocity (forward velocity VX). The scaling factors λ1, λ2, λ3, λ4 and/or offsets may be defined by empirical functions that satisfy the physical constraints as indicated above. They may rely on the Magic Formula parameters under nominal speed and temperature conditions.

A flash temperature TFL may be modeled by a flash temperature module FTM as an instantaneous increase of temperature that depends on the sliding velocity VSL and may be added on the top of the background temperature respectively tire surface temperature TTS.

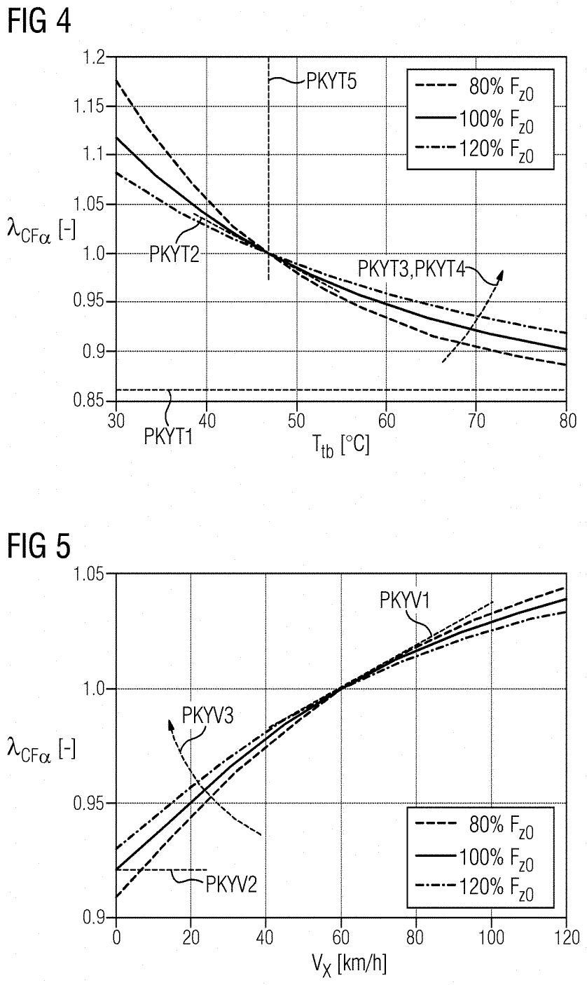

FIGS. 4, 5, 6 illustrate how a scaling factor module SCM may generate scaling factors λ1, λ2, λ3, λ4 which are more specifically termed in these examples.

FIG. 4 depicts the scaling factor for the cornering stiffness λCF, as a function of the tread bulk temperature, for three vertical loads FZ0 and the nominal forward speed. The function is governed by 6 parameters that are identified based on tire forces and moments measurements. PKYT5 refers to the temperature level at which the scaling factor is equal to 1; this value is equal to the temperature at which the cornering stiffness was previously identified. Not indicated in the figure, PKYT6 permits to indicate different levels of nominal temperature at different loads. PKYT2 controls the gain (derivative of scaling factor with respect to the temperature) at nominal load and nominal temperature. PKYT1 is the asymptotic limit for the infinite temperature level. PKYT3 and PKYT4 control the effect of the vertical load on the gain. The function is designed to be monotonically decreasing and asymptotically tending to a lower boundary, to match the behavior of the magnitude of the complex modulus as a function of temperature.

FIG. 5 shows the scaling factor for the cornering stiffness XCF as a function of the forward speed, for three vertical loads FZ0 and nominal temperature, governed by 3 parameters. PKYV1 controls the gain (derivative of scaling factor with respect to the forward speed) at nominal speed and nominal vertical load. PKYV2 represents the scaling factor value when the forward speed tends to 0. It may be noted that an increase of this value also produces a decrease of the asymptotic limit for an infinite forward speed. Finally, PKYV3 defines the dependency of the scaling factor at 0 speed on the vertical load. The function is designed to be monotonically increasing and asymptotically tending to an upper boundary, to match the behavior of the magnitude of the complex modulus as a function of excitation frequency.

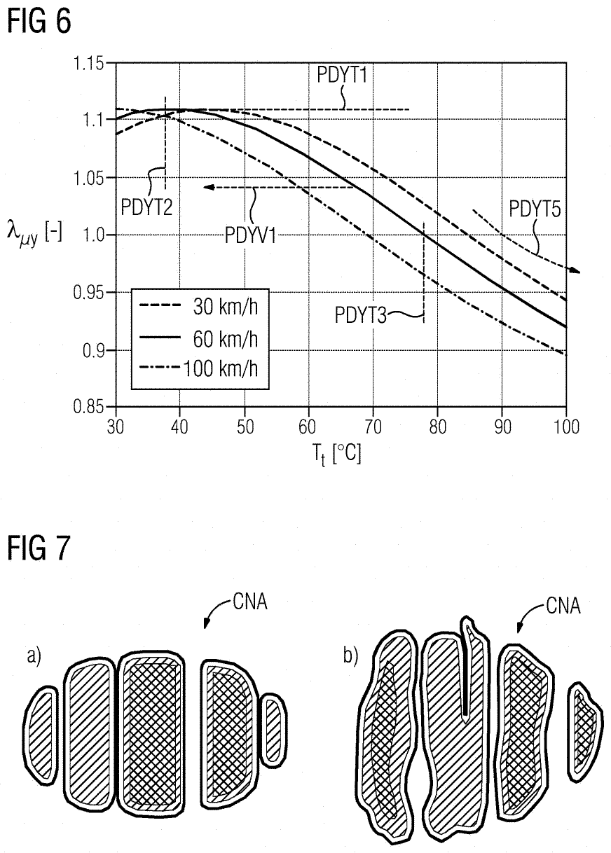

FIG. 6 illustrates the scaling factor for the lateral peak friction λμy as a function of the tread surface temperature, for three levels of the forward speed and the nominal load, governed by 6 parameters. PDYT1 is the maximum value of the scaling factor that is produced at the temperature PDYT2. PDYT3 refers to the temperature level at which the scaling factor is equal to 1. This value is equal to the temperature at which the peak friction was previously identified. Not indicated in the figure, PDYT4 permits to indicate different levels of nominal temperature at different loads. PDYT5 controls the transition from the maximum to the nominal value of the scaling factor and, at the same time, the asymptotic limit for the infinite temperature level. PDYV1 introduces the dependency of the flash temperature on the forward speed, effectively horizontal translating the whole characteristic curve. The function is designed produce a peak at a given temperature and, from there, to asymptotically tend to a lower boundary, to match the behavior of the dissipation factor as a function of temperature.

FIG. 7 shows that a contact pressure profile and the contact patch shape determine to a large extent the distribution of the local frictional forces. The contact pressure profile is relatively constant along the lateral direction of a tire but, when a camber or side slip angle is applied, this profile becomes asymmetric. FIG. 7 depicts the measured contact pressure of a tire in both conditions without (a) and with (b) a camber angle. This effect results in a smaller contact area CNA with an impact on the frictional force. The smaller contact area CNA becomes more sensitive to thermodynamic excitations. The tread surface temperature may be averaged along the lateral direction of the tire by an appropriate weighting function that designates the average temperature along the contact patch portion that most concur to the generation of frictional forces.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer implemented method for simulation of tire performance of a vehicle, the method comprising:
providing a computer implemented tire model, the tire model receiving as an input a vehicle velocity related parameter, and generating as an output a tire driving force related parameter;
providing a computer implemented tire property model comprising a tire temperature model, the tire temperature model receiving as an input the vehicle velocity related parameter, the tire temperature model receiving as an input from the tire model the tire driving force related parameter and the tire temperature model generating as an output a temperature parameter characteristic for the tire temperature; and
transmitting the tire temperature parameter to the tire model as an additional input.

2. The method of claim 1,
wherein the tire temperature model employs the Fourier-diffusion-model for modeling of a tire temperature distribution within the tire, and
wherein the tire temperature distribution is modeled with heat sinks, heat sources, and thermal properties of the tire.

3. The method of claim 1, wherein the tire property model comprises a tire property velocity model receiving as an input the vehicle velocity related parameter, and generating as an output a tire material stiffness parameter.

4. The method of claim 3, wherein the tire temperature parameter and/or the tire material stiffness parameter is/are applied in terms of at least one parameter scaling factor within the tire model.

5. The method of claim 1, further comprising:
transforming, by a scaling factor module, a tire temperature distribution into the tire temperature parameter.

6. The method of claim 5, further comprising:
determining scaling factors by the scaling factor module receiving the tire temperature distribution, the tire temperature parameter, a tire material stiffness parameter, or a combination thereof as an input and generating the parameter scaling factor.

7. The method of claim 5, wherein the scaling factor module comprises at least one of the following scaling factor module parameters: a cornering stiffness parameter (CXN), or a peak friction parameter,
wherein correspondingly the scaling factors (SCF) comprise at least one of: a cornering stiffness scaling factor (CSSF), or a peak friction scaling factor,
wherein a temperature dependency of the tire model parameters is implemented by:
$$scaling factors = \frac{parameter at current temperature}{parameter at reference temperature} .$$

8. The method of claim 1, wherein the vehicle velocity related parameter comprises a vehicle velocity, a tire angular velocity, or a combination thereof.

9. The method of claim 1, wherein the tire driving force related parameter comprises a tire driving force, a momentum, or a combination thereof.

10. The method of claim 1, wherein the tire model comprises at least one of the following tire model parameters:
total vehicle mass, inertia moment around center of mass, wheel base, distance from the center of mass to front axle, distance from the center of mass to rear axle, height of the center of mass, cornering stiffness at the front axle in nominal conditions, cornering stiffness at the rear axle in nominal conditions, roll inertia moment, pitch inertia moment, frontal area, aerodynamic drag, wheel track at the front axle, unsprung mass, static toe angle, static camber angle, steering compliance lateral, steering compliance yaw, suspension spring, or roll bar.

11. A system for simulation of tire performance of a vehicle, the system comprising:
a computer having simulation software comprising:
a tire model configured to receive as an input a vehicle velocity related parameter and generate as an output a tire driving force related parameter; and
a tire property model comprising a tire temperature model configured to receive as an input the vehicle velocity related parameter, wherein the tire temperature model is configured to receive as an input from the tire model the tire driving force related parameter, and wherein the tire temperature model is configured to generate as an output a temperature parameter characteristic for the tire temperature,
wherein the computer is configured to transmit the tire temperature parameter to the tire model as an additional input is the simulation of the tire performance of the vehicle.

12. A tire modeling device comprising a computer with a simulation software, wherein the simulation software is configured to simulate tire performance of a vehicle by:
providing a computer implemented tire model, the tire model receiving as an input a vehicle velocity related parameter, and generating as an output a tire driving force related parameter;
providing a computer implemented tire property model comprising a tire temperature model, the tire temperature model receiving as an input the vehicle velocity related parameter, the tire temperature model receiving as an input from the tire model the tire driving force related parameter, and the tire temperature model generating as an output a temperature parameter characteristic for the tire temperature; and
transmitting the tire temperature parameter to the tire model as an additional input.
